(19) United States
(12) Patent Application Publication
(10) Pub. No.: US 2015/0350261 A1
(43) Pub. Date: Dec. 3, 2015

(54) INTERLEAVING PRIMARY AND PRIVATE CONVERSATIONS

(71) Applicant: Linkedln Corporation, Mountain View, CA (US)

(72) Inventors: Steven Foote, Santa Clara, CA (US); Prayrit Jain, Mountain View, CA (US); Jimmy Honlam Chan, Fremont, CA (US); Scott Blackburn, Los Altos, CA (US)

(73) Assignee: Linkedln Corporation, Mountain View, CA (US)

(21) Appl. No.: 14/292,627

(22) Filed: May 30, 2014

(51) Int. Cl. H04L 29/06; G06F 3/0484; G06F 17/21

(52) U.S. Cl. CPC H04L 65/403; G06F 17/214; G06F 3/04842

(57) ABSTRACT

A system and method for interleaving primary and private messages includes establishing, with a processor, a primary conversation among a primary group of users, receiving a command from at least one of the users to establish a private group including some but not all of the users of the primary group, establishing, with the processor, the private conversation among the private group, and causing a user interface to display the private conversation only to the private group, the private conversation being interleaved on the user interface with the primary conversation.

### TECHNICAL FIELD

The subject matter disclosed herein generally relates to interleaving web-based primary and private conversations.

### BACKGROUND

Websites and various internet and intranet sites (collectively referred to herein as “websites”) often allow for the posting of messages as part of a conversation. For instance, chat rooms, social networks, blogs, content providers, and the like may allow users of the various websites to initiate or participate in a conversation by posting individual messages. Such messages may be in the form of comments on an article or social network posting, initiating or contributing to a thread in a chat room, and the like. Messages may, for instance, initiate a conversation or may be responses to a previously initiated conversation.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network, in an example embodiment.

FIG. 2 is a system for interleaving private and primary conversations, in an example embodiment.

FIGS. 3A and 3B are abstract illustrations of a display screen of user interfaces of user devices, in example embodiments.

FIGS. 4A-4E are illustrations of examples of indicia of private messages.

FIG. 5 is a flowchart for interleaving primary and private messages, in an example embodiment.

FIG. 6 is a block diagram illustrating components of a machine able to read instructions from a machine-readable medium.

### DETAILED DESCRIPTION

Example methods and systems are directed to interleaving primary and private conversations. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Conventional website messaging may display or make accessible all of the messages of a conversation. For instance, all of the messages may be automatically displayed to anyone who looks at the conversation. Alternatively or additionally, some or all messages may be concealed and may be accessed by expanding the conversation or accessing a new webpage, such as through a menu command, an icon, or the like. As such, conventional web-based conversations may not provide for the ability to discriminate between what users of the webpage see what messages in the conversation.

A conversation management system has been developed that allows for the creation of private conversations that are interleaved with a primary conversation. For instance, the primary conversation may be accessible to a primary group, such as the general public or all of the employees of a company, members of an organization, group, team, or the like. A user in the primary group may specify a private group that may participate in a private conversation interleaved with the primary conversation. Such interleaving may take the form of messages of the private conversation being positioned within the primary conversation as if the private messages were part of the primary conversation. However, such private messages may not be visible to users of the primary group who are not users of the private group. Thus, users of the private group may see the private messages positioned in the context of the primary conversation while keeping the messages private from users who are not part of the private group.

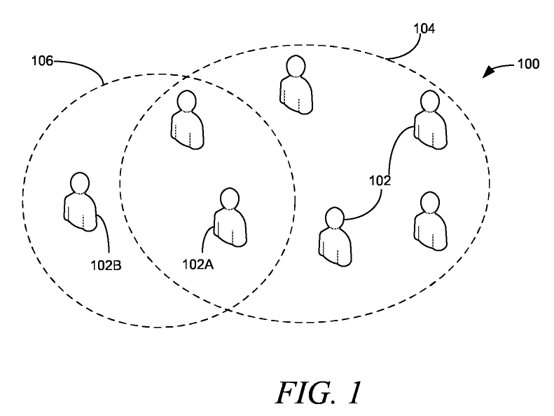

FIG. 1 is an illustration of a community 100 of users 102, in an example embodiment. Each user 102 may be a person, a user device that is accessible by a person, or other entity that may post web-based messages as part of a conversation. The community 100 includes a primary group 104. While, as illustrated, the primary group 104 does not include all of the users 102 in the community 100, it is to be understood that the primary group 104 may be coextensive with the community 100. The community 100 and/or the primary group 104 may be the public at large, employees/coworkers, members of an organization, an informal association, and the like. The primary group 104 may be defined as all those who have access to a webpage on which the conversations disclosed herein may be displayed.

The community 100 further includes a private group 106. The private group 106 may be formed based on a command by a user 102A of the primary group 104. The command may specify individual users 102 who are to be incorporated into the private group 106. In the illustrated example, the private group 106 includes a user 102B of the community 100 who is not a member of the primary group 104. In various alternative examples, all of the users 102 of the private group 106 must be users 102 of the primary group 104.

The private group 106 may be ad hoc and subject to being disbanded. The private group 106 may be disbanded based on a command received from the user 102A or from any user 102 or administrator who is empowered to manage the status of the private group 106. Users 102 of the private group 106 may be added or removed, based on the receipt of commands to do so. Alternatively, the private group 106 and/or the membership of the private group 106 may be established on a permanent basis.

Multiple private groups 106 may be formed within the context of the primary group 104. Thus, various private groups 106 may include various users 102 of the community 100. A user 102 may be part of more than one private group 106 simultaneously. A user 102 who is part of multiple private groups 106 may see the messages of each of the private groups 106 to which the user 102 corresponds displayed within the context of the messages of the primary group 104.

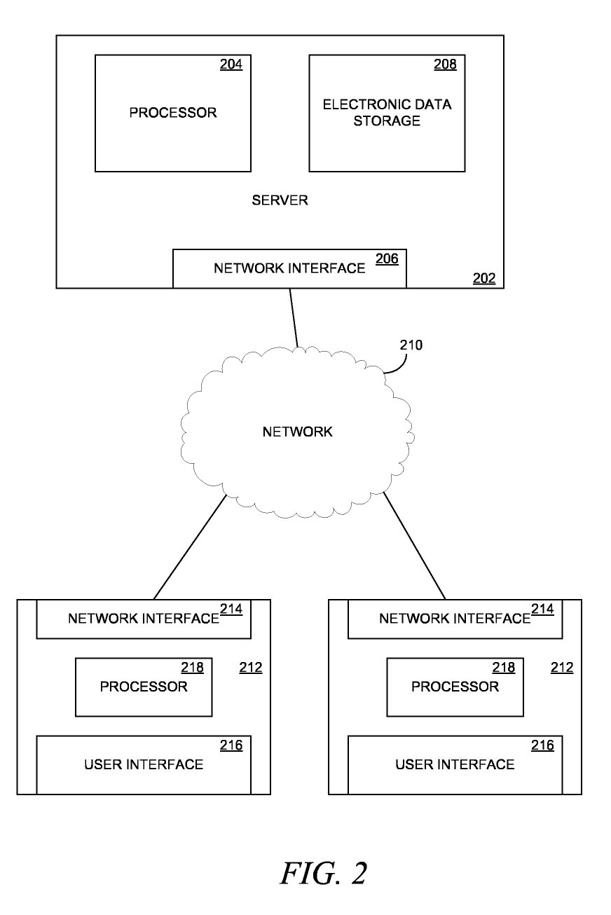

FIG. 2 is a system 200 for interleaving private and primary conversations, in an example embodiment. The system 200 may be utilized by or on behalf of the community 100 and the users 102 therein. The system 200 may variously and optionally include some or all of the components described herein.

As illustrated, the system 200 includes a server 202 including a processor 204, a server network interface 206, and an electronic storage 208, among other components that may optionally or conventionally be components of a server. The server 202 is coupled or is coupleable to a network 210 via the server network interface 206. The network 210 may be a private or public network. Multiple user devices 212 include a device network interface 214 that is coupled to or is coupleable to the network 210 and a user interface 216. The user interface 216 is or may include various user interface components, including but not limited to those disclosed herein, such as a display, a keyboard, a touchscreen, and so forth. The user device 212 optionally includes a processor 218.

The system 200 may utilize “cloud computing” technologies, as known in the art. For instance, the server 202 may be distributed between and among various individual servers or other computing and/or networking platforms. The processing provided by the processor 218 of the user device 212 may be supplemented by or replaced altogether by the processor 204 of the server 202 or a processor that is otherwise coupled to the network 210. Similarly, the user device 212 may access the electronic storage 208 or other electronic storage coupled to the network 210.

The network interfaces 206, 214 may be utilized to establish and/or facilitate conversations between and among the users 102 via the network 210. A user 102 may use the user interface 216 to enter messages for the primary conversation and private conversations of private groups 106 of which the user 102 is a member. The user interface 216 may further be utilized by users 102 to enter commands to establish private groups 106 among the users 102 of the community 100. Such commands may specify individual users 102 or groups of users 102. In various examples, the private groups 106 may include some but not all of the users 102 that are members of the primary group 104. The user interface 216 may further be utilized to enter commands terminating associated private groups 106.

The processor 204 may receive the commands entered via the user interface 216 and establish the private groups 106 accordingly. The processor 204 may save lists of users 102 that correspond to particular private groups 106 in the electronic storage 208 and erase or render inactive lists of users 102 of private groups 106 for which termination commands have been received. The processor 204 may additionally receive messages submitted to the primary and/or private conversations, store the messages in the electronic storage 208, and transmit commands via the network interface 206 and network 210 to the user devices 212 to display the various messages on the user interfaces 216 for appropriate users 102. The processor 204 may cause such messages to be sent only to appropriate users depending on the users 102 belonging to the primary group 104 or private group 106 to which the message corresponds. Thus, a message for the primary conversation may be sent to all users 102 of the primary group 104 while a message for a particular private conversation may be sent only to the users 102 of the private group 106 that corresponds to the private conversation. The processor 204 may further cause the messages to be interleaved as appropriate on the respective user interfaces 216, as will be disclosed in detail herein.

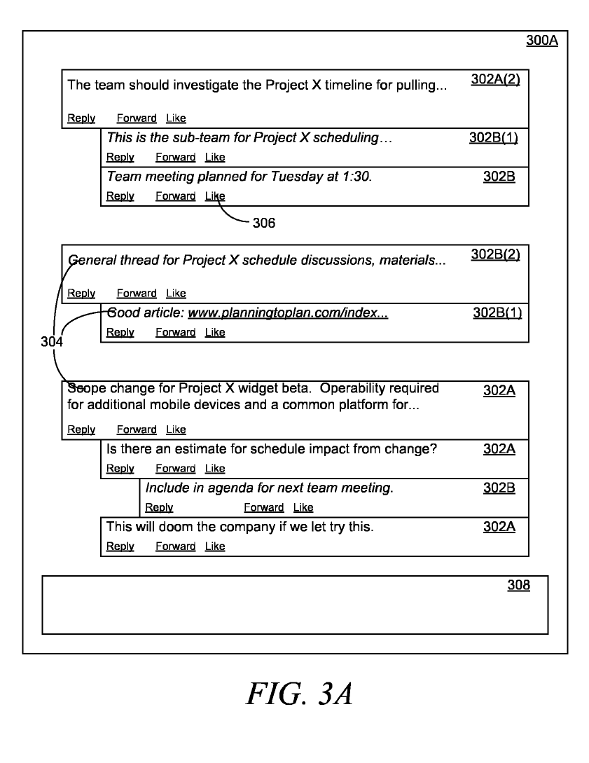

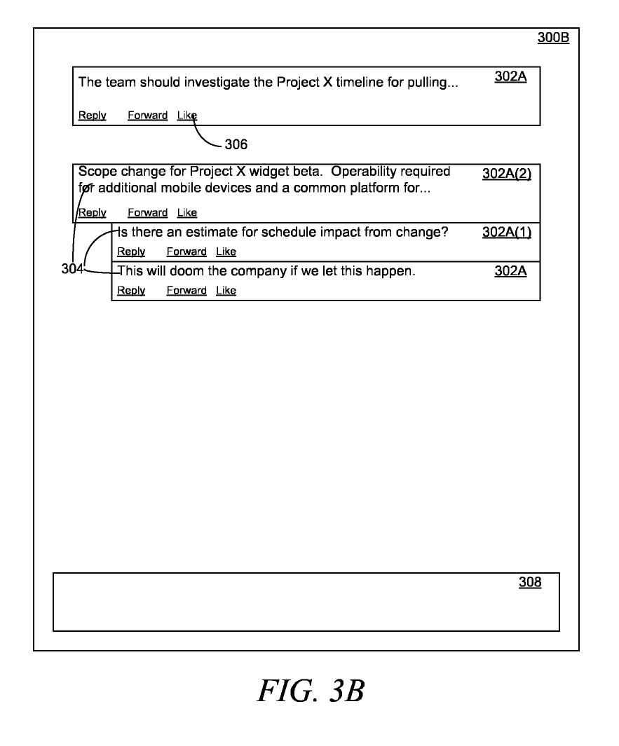

FIGS. 3A and 3B are abstract illustrations of a display screen 300A, 300B, respectively, of user interfaces 216 of user devices 212, in example embodiments. The first display screen 300A corresponds to a user 102 who is a member of both the primary group 104 and the private group 106. The second display screen 300B corresponds to a user who is a member of the primary group 104 but not the private group 106. Thus, the display screen 300A includes the primary conversation and the private conversation while the display screen 300B includes the primary conversation but not the private conversation.

Each conversation includes messages 302, the primary conversation including primary messages 302A and the private conversation including private messages 302B. Each message 302 includes content 304, such as text, graphics, files, and other forms of content that may be displayed on a website. Some or all of the messages 300 further include interaction selections 306, such as reply, forward, “like,” and so forth.

Private messages 302B are denoted by an indicia. As illustrated, the indicia is that the content 304 of the private messages 302B is italicized. However, as will be illustrated herein, the indicia may be any of a variety of indicia that may denote the private messages 302B as such. Private messages 302B from different private conversations may be denoted with different indicia.

A user 102 may post a message 300 to a conversation via a content entry field 308. The user 102 may, for instance, enter text or a link to a file to be posted. The content entry field 308 may further function as a command line for entering commands to establish private groups 106.

Entering content to the content entry field 308 causes the content to be displayed as a message 302. In various examples, the user may specify whether the message 302 is to be for the primary conversation or the private conversation. In various examples, a message 302 is defaulted as for the primary conversation. In various examples, the display 300 includes a menu to select a conversation to which the message 302 corresponds.

When a user 102 selects “reply” in the interactions elections 306 to a given message 302, entry of content into the content entry field 308 may cause the resultant message 302 to be displayed as a child message 302A(1)/302B(1) (collectively “302(1)”) to a the parent message 302A(2)/302B(2) (collectively “302(2)”) for which “reply” was selected. The child message 302(1) may be denoted as a child message according to a variety of indicators, as illustrated by indenting the child message 302(1), but optionally by changing a font of the message 302 or otherwise providing some indication of the parent-child relationship of the messages 302. The indication of the child message 302(1) may be different from the indicia of the private message 302B.

The private conversation may be interleaved with the primary conversation by interleaving individual messages 302 of the respective conversations. Thus, if a user 102 selects “reply” to a parent primary message 302A and enters a private message 302B, then the private message 302B appears on the display 300A as a child message 302(1). Subsequent replies to the parent primary message 302A with primary messages 302A may appear as child messages 302(1) after the child private message 302B. It is noted that a private child message 302 includes both indicia for being a private message 302B and being a child message 302(1), as illustrated both italicized and indented. Consequently, the private messages 302B are interleaved with the primary messages 302A on the display 300A.

Because the display 300B corresponds to a user 102 who is not part of the private group 106, however, the private messages are not displayed. Thus, only the primary messages 302A are displayed. The primary messages 302 may be displayed as if the private messages 302B did not exist.

The command to establish a private conversation may specify the members of the private group 106. For instance, the command may be text based, such as by denoting the creation of the private group 106 and the users 102 of the private group 106. In an example, the command may read “*private: John Doe; Jane Roe; Robert Smith; Betty Jones”. The syntax presented here is for example and any of a variety of syntaxes may be utilized to create the command. Additionally or alternatively, the command may be entered via a graphical interface. For instance, a user may select “create private group” in a menu and be presented with a list or a lookup capability for the users 102 in the community 100, who may be selected on an individual basis.

The private group 106 may further or alternatively be selected by selecting subgroups of users. For instance, in a company or organization, a private group 106 may be established, at least in part, by selecting one or more pre-configured teams or subordinates of a manager, and so forth. Thus, users 102 may be added to the private group 106 not necessarily on an individual basis.

Primary messages 302A may be displayed or be displayable on the user interface 216 of each user device 212 corresponding to each user 102 of the primary group 104. Private messages 302B may be displayed or be displayable on the user interface 216 of each user device 212 corresponding to each user 102 of the associated private group 106. Thus, each message 302 may be displayed or be displayable to a user 102 that belongs to a group with which the message 302 is associated.

In an example scenario or circumstance in which the primary and private conversations may be implemented, the primary group 104 may be engaged in the primary conversation, with users 102 of the primary group 104 posting messages 302 for display on the user devices 212 of the users of the primary group 104. A user 102 in the primary group 104 may note a message 302 in the conversation that may, for instance, usefully be followed up on by some but not all of the users 102 of the community, such as if the message included a question that required research or consultation. The user 102 may input a command selecting individual users 102 or a team of users 102 and denote them as a private group 106. The user 102 may then post a private message 302B to the private group, establishing the private conversation. The private group 106 may then converse with private messages 302B to address the private matter and then post a primary message 302A in answer to the original question.

Because the private messages 302A are interleaved with the primary messages the context of the primary conversation is maintained. Thus, if the initiator user 102 of the private conversation initiates the private conversation by making a private message 302B a “reply” to a primary message 302A, the other members of the private group 106 may have the context of the private message 302B readily available. The private conversation may thus proceed within the context of the primary conversation, with users 102 of the private group 106 able to see the messages of the private conversation in the context of the primary conversation.

While the display 300A shows messages 302 interleaved vertically, it is to be understood that the interleaving of messages 302 and of the primary and private conversations generally may be horizontal or along any other axis. Moreover, the principles described here may be applied in circumstances in which the private messages 302B are displayed within the context of the primary messages 302A with which the private messages 302B are associated. Thus, the principles disclosed herein may be applied so that the private messages 302B are not necessarily interleaved with the primary messages 302A but rather are displayed such that the context of the private messages 302B with respect to related primary messages 302A is apparent and made clear to a user 102. For instance, primary messages 302A may be displayed in a first column, row, window, or the like, and private messages 302B may be displayed in a second column, row, window, or the like, with an indicator of an associated primary message 302A, e.g., a line drawn between a parent primary message 302A of a child private message 302B, among a variety of alternative indicators of a context of the private messages 302B.

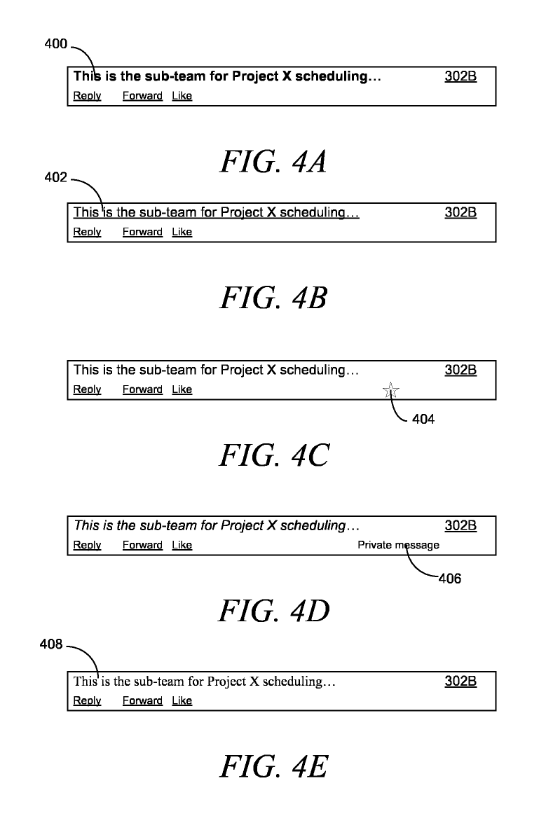

FIGS. 4A-4E are illustrations of examples of indicia of private messages 302B. The illustrated examples are in addition to the italicized indicia illustrated in FIG. 3A and are not exhaustive.

FIG. 4A shows a private message 302B in which the indicia is bold typeface 400. FIG. 4B shows a private message 302B in which the indicia is underlined typeface 402. FIG. 4C shows a private message 302B in which the indicia is an icon 404. FIG. 4D shows a private message 302B in which the indica is text 406, as illustrated “private message”. FIG. 4E shows a private message 302B in which the indicia is a font 408, as illustrated a serif font as opposed to sans serif for the primary messages 302A. An indicia not illustrated herein is a text color, such as by making at least some portion of the private message 302B an alternate color, such as red as opposed to black for the primary messages 302A.

### Flowchart

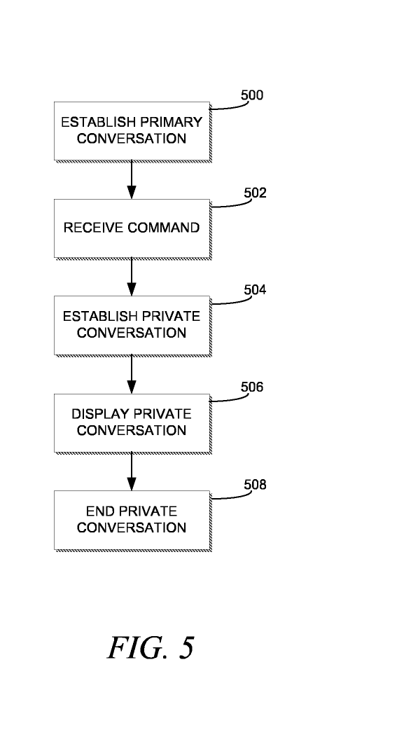

FIG. 5 is a flowchart for interleaving primary and private messages, in an example embodiment. The flowchart may be performed with any of a variety of devices and systems disclosed herein, as well as with any suitable system known in the art.

At operation 500, a primary conversation is established with a processor among a primary group of users.

At operation 502, a command is received from at least one of the users to establish a private group including some but not all of the users of the primary group. In an example, the private group further includes at least one user who is not a user of the primary conversation. In an example, the primary conversation is not viewable by the at least one user of the private group who is not a user of the primary group. In an example, the command includes a selection of individual users of the primary group for inclusion in the private group.

At operation 504, the private conversation is established by a processor among the private group.

At operation 506, a user interface is caused to display the private conversation only to the private group, the private conversation being interleaved on the user interface with the primary conversation. In an example, each of the primary and the private conversations include a plurality of messages, and wherein the primary and private conversations are interleaved by positioning messages from the private conversation between messages of the primary conversation. In an example, a parent message of the primary conversation includes at least one child message from at least one of the primary conversation and the private conversation, the child message being positioned with respect to the parent message. In an example, the child message is from the private conversation.

In an example, each of the primary and the private conversations include a plurality of messages, wherein the messages of the private conversation include an indicia of being part of the private conversation. In an example, the indicia includes at least one of a text, an icon, an indentation relative to the messages of the primary conversation, a font, and a color.

At operation 508, the private conversation is ended based on receiving a termination command from a user of the private group.

### System

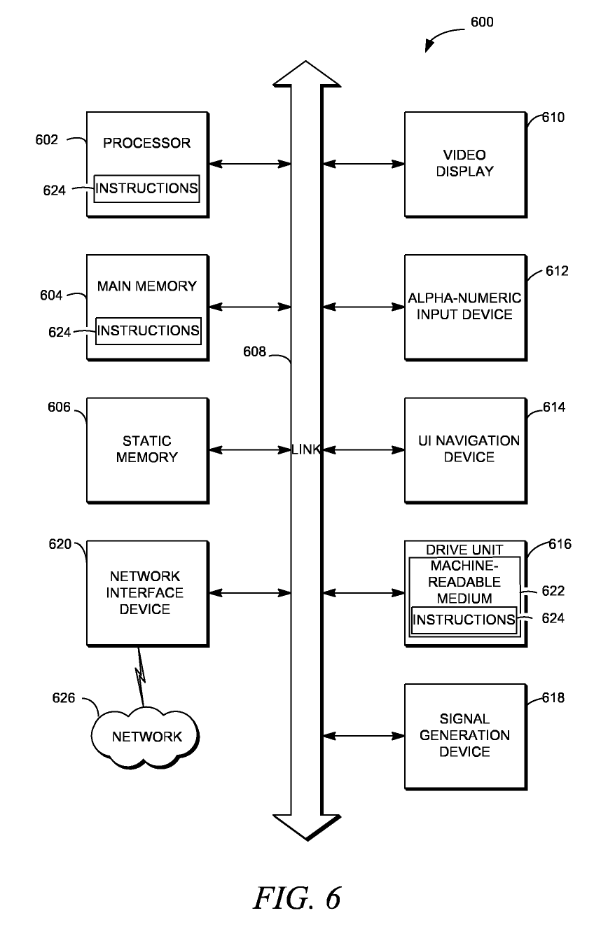

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
establishing, with a processor, a primary conversation among a primary group of users;
receiving a command from at least one of the users to establish a private group including some but not all of the users of the primary group;
establishing, with the processor, the private conversation among the private group; and
causing a user interface to display the private conversation only to the private group, the private conversation being interleaved on the user interface with the primary conversation.

2. The method of claim 1, wherein the private group further includes at least one user who is not a user of the primary conversation.

3. The method of claim 2, wherein the primary conversation is not viewable by the at least one user of the private group who is not a user of the primary group.

4. The method of claim 1, further comprising ending the private conversation based on receiving a termination command from a user of the private group.

5. The method of claim 1, wherein each of the primary and the private conversations include a plurality of messages, and wherein the primary and private conversations are interleaved by positioning messages from the private conversation between messages of the primary conversation.

6. The method of claim 5, wherein a parent message of the primary conversation includes at least one child message from at least one of the primary conversation and the private conversation, the child message being positioned with respect to the parent message.

7. The method of claim 6, wherein the child message is from the private conversation.

8. The method of claim 1, wherein each of the primary and the private conversations include a plurality of messages, wherein the messages of the private conversation include an indicia of being part of the private conversation.

9. The method of claim 8, wherein the indicia includes at least one of a text, an icon, an indentation relative to the messages of the primary conversation, a font, and a color.

10. The method of claim 1, wherein the command includes a selection of individual users of the primary group for inclusion in the private group.

11. A system comprising:
a network interface, configured to be coupled to a network, for establishing a primary conversation among a primary group of users;
a processor, communicatively coupled to the network interface, configured to:
receive a command from at least one of the users to establish a private group including some but not all of the users of the primary group; and;
establish the private conversation among the private group; and
cause a user interface to display the primary and the private conversations, the private conversation only being visible to the private group and being interleaved with the primary conversation.

12. The system of claim 11, wherein the private group further includes at least one user who is not a user of the primary group.

13. The system of claim 12, wherein processor causes the user interface to not display the primary conversation on the user interface to the at least one user of the private group who is not a user of the primary group.

14. The system of claim 11, wherein the processor is further configured to end the private conversation based on receiving a termination command from a user of the private group.

15. The system of claim 11, wherein each of the primary and the private conversations include a plurality of messages, and wherein the processor is configured cause the user interface to interleave the primary and private conversations by causing the user interface to position messages from the private conversation between messages of the primary conversation.

16. The system of claim 15, wherein a parent message of the primary conversation includes at least one child message from at least one of the primary conversation and the private conversation, the child message being positioned with respect to the parent message.

17. The system of claim 16, wherein the child message is from the private conversation.

18. The system of claim 11, wherein each of the primary and the private conversations include a plurality of messages, wherein the messages of the private conversation include an indicia of being part of the private conversation.

19. The system of claim 18, wherein the indicia includes at least one of a text, an icon, an indentation relative to the messages of the primary conversation, a font, and a color.

20. The system of claim 11, wherein the command includes a selection of individual users of the primary group for inclusion in the private group.

21. A user device comprising:
a network interface configured to be communicatively coupled to a network; and
a user interface configured to:
display a primary conversation among users of a primary group;
receive a command from at least one of the users to establish a private group including some but not all of the users of the primary group; and;
display the private conversation, the private conversation being visible only to the private group and being interleaved with the primary conversation.

22. The user device of claim 21, wherein the private group further includes at least one user who is not a user of the primary group.

23. The user device of claim 22, wherein the user interface does not display the primary conversation on the user interface to the at least one user of the private group who is not a user of the primary group.

24. The user device of claim 21, wherein the user interface is further configured to receive at termination command from a user of the private group to end the private conversation.

25. The user device of claim 21, wherein each of the primary and the private conversations include a plurality of messages, and wherein the user interface interleaves the primary and private conversations by positioning messages from the private conversation between messages of the primary conversation.

26. The user device of claim 25, wherein a parent message of the primary conversation includes at least one child message from at least one of the primary conversation and the private conversation, the child message being positioned with respect to the parent message.

27. The user device of claim 26, wherein the child message is from the private conversation.

28. The user device of claim 21, wherein each of the primary and the private conversations include a plurality of messages, wherein the user interface displays messages of the private conversation including an indicia of being part of the private conversation.

29. The user device of claim 28, wherein the indicia includes at least one of a text, an icon, an indentation relative to the messages of the primary conversation, a font, and a color.

30. The user device of claim 21, wherein the command includes a selection of individual users of the primary group for inclusion in the private group.
